(19) United States
(12) Patent Application Publication
(10) Pub. No.: US 2026/0172146 A1
(43) Pub. Date: Jun. 18, 2026

(54) SYSTEMATIC POLAR ENCODING OPERATION

(71) Applicant: QUALCOMM Incorporated, San Diego, CA (US)

(72) Inventors: Wei YANG, San Diego, CA (US); Kirill IVANOV, La Jolla, CA (US)

(21) Appl. No.: 18/980,565

(22) Filed: Dec. 13, 2024

(51) Int. Cl. H04L 1/00

(52) U.S. Cl. CPC H04L 1/0057

(57) ABSTRACT

Various aspects of the present disclosure generally relate to wireless communication. A systematic polar encoding operation may include a first polar encoding operation in accordance with a first polar matrix and a second polar encoding operation in accordance with a second polar matrix that is larger than the first polar matrix. To perform the systematic polar encoding operation, a first device may perform the first polar encoding operation on the set of information bits to obtain a first set of intermediate bits, and may map the first set of intermediate bits contiguously to the second polar encoding operation. The first device may copy a subset of the first set of intermediate bits to generate a second set of intermediate bits. Then, the first device may perform the second polar encoding operation on the first and second sets of intermediate bits to obtain a systematically polar encoded codeword.

### FIELD OF THE DISCLOSURE

Aspects of the present disclosure generally relate to wireless communication and specifically relate to techniques, apparatuses, and methods associated with a systematic polar encoding operation.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method for wireless communication by a first device. The method may include performing a first polar encoding operation on a set of information bits to obtain a first set of intermediate bits. The method may include mapping the first set of intermediate bits contiguously to a second polar encoding operation. The method may include performing the second polar encoding operation on the first set of intermediate bits and a second set of intermediate bits to obtain a systematically polar encoded codeword. The method may include transmitting the systematically polar encoded codeword to a second device, wherein the systematically polar encoded codeword comprises a contiguous set of encoded bits corresponding to the set of information bits and one or more additional encoded bits.

Some aspects described herein relate to a method for wireless communication by a first device. The method may include receiving, from a second device, a systematically polar encoded codeword comprising a contiguous set of encoded bits corresponding to a set of information and one or more additionally encoded bits. The method may include performing a first polar decoding operation on the systematically polar encoded codeword to obtain a first set of intermediate bits and a second set of intermediate bits. The method may include mapping the second set of intermediate bits contiguously to a second polar decoding operation. The method may include performing the second polar decoding operation on the second set of intermediate bits to obtain the set of information bits.

Some aspects described herein relate to a first device for wireless communication. The first device may include a processing system that includes one or more processors and one or more memories coupled with the one or more processors. The processing system may be configured to cause the first device to perform a first polar encoding operation on a set of information bits to obtain a first set of intermediate bits. The processing system may be configured to cause the first device to map the first set of intermediate bits contiguously to a second polar encoding operation. The processing system may be configured to cause the first device to perform the second polar encoding operation on the first set of intermediate bits and a second set of intermediate bits to obtain a systematically polar encoded codeword. The processing system may be configured to cause the first device to transmit the systematically polar encoded codeword to a second device, wherein the systematically polar encoded codeword comprises a contiguous set of encoded bits corresponding to the set of information bits and one or more additional encoded bits.

Some aspects described herein relate to a first device for wireless communication. The first device may include a processing system that includes one or more processors and one or more memories coupled with the one or more processors. The processing system may be configured to cause the first device to receive, from a second device, a systematically polar encoded codeword comprising a contiguous set of encoded bits corresponding to a set of information and one or more additionally encoded bits. The processing system may be configured to cause the first device to perform a first polar decoding operation on the systematically polar encoded codeword to obtain a first set of intermediate bits and a second set of intermediate bits. The processing system may be configured to cause the first device to map the second set of intermediate bits contiguously to a second polar decoding operation. The processing system may be configured to cause the first device to perform the second polar decoding operation on the second set of intermediate bits to obtain the set of information bits.

Some aspects described herein relate to a non-transitory computer-readable medium that stores a set of instructions for wireless communication by a first device. The set of instructions, when executed by one or more processors of the first device, may cause the first device to perform a first polar encoding operation on a set of information bits to obtain a first set of intermediate bits. The set of instructions, when executed by one or more processors of the first device, may cause the first device to map the first set of intermediate bits contiguously to a second polar encoding operation. The set of instructions, when executed by one or more processors of the first device, may cause the first device to perform the second polar encoding operation on the first set of intermediate bits and a second set of intermediate bits to obtain a systematically polar encoded codeword. The set of instructions, when executed by one or more processors of the first device, may cause the first device to transmit the systematically polar encoded codeword to a second device, wherein the systematically polar encoded codeword comprises a contiguous set of encoded bits corresponding to the set of information bits and one or more additional encoded bits.

Some aspects described herein relate to a non-transitory computer-readable medium that stores a set of instructions for wireless communication by a first device. The set of instructions, when executed by one or more processors of the first device, may cause the first device to receive, from a second device, a systematically polar encoded codeword comprising a contiguous set of encoded bits corresponding to a set of information and one or more additionally encoded bits. The set of instructions, when executed by one or more processors of the first device, may cause the first device to perform a first polar decoding operation on the systematically polar encoded codeword to obtain a first set of intermediate bits and a second set of intermediate bits. The set of instructions, when executed by one or more processors of the first device, may cause the first device to map the second set of intermediate bits contiguously to a second polar decoding operation. The set of instructions, when executed by one or more processors of the first device, may cause the second device to perform the second polar decoding operation on the first set of intermediate bits to obtain the set of information bits.

Some aspects described herein relate to an apparatus for wireless communication. The apparatus may include means for performing a first polar encoding operation on a set of information bits to obtain a first set of intermediate bits. The apparatus may include means for mapping the first set of intermediate bits contiguously to a second polar encoding operation. The apparatus may include means for performing the second polar encoding operation on the first set of intermediate bits and a second set of intermediate bits to obtain a systematically polar encoded codeword. The apparatus may include means for transmitting the systematically polar encoded codeword to a second device, wherein the systematically polar encoded codeword comprises a contiguous set of encoded bits corresponding to the set of information bits and one or more additional encoded bits.

Some aspects described herein relate to an apparatus for wireless communication. The apparatus may include means for receiving, from a second device, a systematically polar encoded codeword comprising a contiguous set of encoded bits corresponding to a set of information and one or more additionally encoded bits. The apparatus may include means for performing a first polar decoding operation on the systematically polar encoded codeword to obtain a first set of intermediate bits and a second set of intermediate bits. The apparatus may include means for mapping the second set of intermediate bits contiguously to a second polar decoding operation. The apparatus may include means for performing the second polar decoding operation on the second set of intermediate bits to obtain the set of information bits.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated network node architecture in accordance with the present disclosure.

FIGS. 3 through 5 are diagrams illustrating examples of systematic polar encoding operations in accordance with the present disclosure

FIG. 6 is a diagram illustrating an example process for generating a set of intermediate bits in accordance with the present disclosure.

FIG. 7 is an example of a process flow that supports systematic polar encoding operations in accordance with the present disclosure.

FIGS. 8 and 9 are flowcharts illustrating example processes performed that support systematic polar encoding operations in accordance with the present disclosure.

FIGS. 10 and 11 are diagrams of example apparatuses for wireless communication that support systematic polar encoding operations in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, wireless communication devices (such as network nodes or user equipments (UEs)) may communicate using polar codes. That is, a transmitting device may perform one or more polar encoding operations (such as corresponding to one or more polar codes) on a set of information bits to obtain a polar encoded codeword. In some cases, the polar codes may correspond to non-systematic polar codes or systematic polar codes. For non-systematic polar codes, the set of information bits may not appear directly in the non-systematically polar encoded codeword. Additionally, for systematic polar codes, the set of information bits may appear directly in the systematically polar encoded codeword. That is, the systematically polar encoded codeword may include the set of information bits and a set of frozen bits, and the set of information bits may be placed in the more reliable bit channels of the polar encoding operation and the frozen bits may be placed in the less reliable bit channels of the polar encoding operation. In some cases (such as for binary uniform sources), systematic and non-systematic polar codes may be associated with similar block error rates (BLERs). However, systematic polar codes may be associated with improved bit error rates than non-systematic polar codes.

Some wireless communication devices may perform a systematic polar encoding operation by performing, in accordance with a polar matrix, a first polar encoding operation on the set of information bits to obtain a set of intermediate bits and performing, in accordance with the polar matrix, a second polar encoding operation on the set of intermediate bits to obtain the codeword. That is, the wireless communication device may perform systematic polar encoding by performing a non-systematic polar encoding operation twice in accordance with the same polar matrix. In this example, a location of the systematic bits in the codeword may be the same as the location of the set of information bits in a U-domain (such as corresponding to the input to the first polar encoding operation). To decode the systematically polar encoded codeword, a receiving device may also perform two polar decoding operations in accordance with the same polar matrix.

But performing a systematic polar encoding operation based on performing a non-systematic polar encoding operation twice may increase an encoding complexity and an encoding latency as compared to non-systematic polar encoding operations (such as twofold). Additionally, the systematic polar decoding operation may be associated with an increased complexity and latency as compared to the non-systematic polar decoding operation (such as due to the receiving device performing two polar decoding operations). Accordingly, non-systematic polar codes may be associated with decreased complexity and latency as compared to systematic polar codes. But some wireless communication devices may still communicate systematically polar encoded codewords. That is, systematic polar codes may be associated with improved bit error rates as compared to non-systematic polar codes. Additionally, systematic polar codes may enable a transmitting device to more effectively exploit side information about a source as compared to non-systematic polar codes.

Various aspects relate generally to systematic polar encoding operations that are associated with a decreased latency and complexity as compared to systematic polar encoding operations where a same non-systematic polar encoding operation is performed twice. Some aspects more specifically relate to systematic polar encoding operations that include a first polar encoding operation in accordance with a first polar matrix (that is smaller than the polar matrix associated with the non-systematic polar encoding matrix that is used twice to perform a systematic polar encoding operation) and a second polar encoding operation in accordance with a second, different, polar matrix that is larger than the first polar matrix (and that is a same size as the polar matrix associated with the non-systematic polar encoding matrix that is used twice to perform the systematic polar encoding operation). To perform the systematic polar encoding operation, a first device (such as a transmitting wireless communication device) may perform the first polar encoding operation on the set of information bits to obtain a first set of intermediate bits, and may then map the first set of intermediate bits contiguously to the second polar encoding operation.

Additionally, the first device may generate a second set of intermediate bits to map to the second polar encoding operation based on the second polar encoding operation being in accordance with a second polar matrix that is larger than the first polar matrix. To generate the second set of intermediate bits, the first device may copy a subset of the first set of intermediate bits that, when mapped contiguously to the second polar encoding operation, are mapped to frozen bit locations associated with the second polar encoding operation. Then, the first device may map the first set of intermediate bits to a first set of indices of the second polar encoding operation (such as the larger indices of the second polar encoding operation that correspond to the bottom of the second polar matrix) and the second set of intermediate bits to a second set of indices of the second polar encoding operation (such as the smaller indices of the second polar encoding operation that correspond to the top of the second polar matrix). The first device may then perform the second polar encoding operation on the first and second sets of intermediate bits to obtain a systematically polar encoded codeword. In some cases, the codeword may include a contiguous set of bits corresponding to the systematically encoded bits, and a location of the systematically encoded bits may be fixed (such as independent from the polar sequence design). For example, the last quantity of bit locations within the codeword may include the systematically encoded bits.

Particular aspects of the subject matter described in this disclosure can be implemented to realize one or more of the following potential advantages. In some examples, the described techniques can be used to reduce a latency and complexity associated with systematic polar encoding operations. That is, the first polar matrix that is associated with the first polar encoding operation may be smaller than the polar matrix associated with other systematic polar encoding operations (where the same non-systematic polar encoding operation is performed twice). Based on the first polar matrix being smaller, the complexity and latency associated with performing the first polar encoding operation may be reduced as compared to a first polar encoding operation associated with other systematic polar encoding operations. Further, the described techniques of generating the second set of intermediate bits by copying the subset of the first set of intermediate bits that, when mapped contiguously to the second polar encoding operation, are mapped to frozen bit locations associated with the second polar encoding operation may enable the first device to perform a less complex first polar encoding operation (such as based on the smaller first polar matrix) without losing any of the information within the set of information bits (such as due to one or more of the bits within the first set of intermediate bits being mapped to frozen bit locations within the second polar encoding operation).

Additionally, the location of the systematically encoded bits being fixed (such as instead of being dependent on the polar sequence design) may reduce a complexity associated with the systematic polar decoding operation performed by a second, receiving device. That is, the location of the systematic bits being fixed within the codeword may decrease a complexity of log likelihood radio (LLR) generation performed by the receiving device, as the receiving device may no longer have to look up the polar code sequence to determine the locations of the systematic bits and cyclic redundancy check (CRC) bits to perform the LLR generation. Further, the last quantity of bit locations within the codeword including the systematic bits may improve a reliability of transmitting the systematically polar encoded codeword. That is, the systematic bits may be mapped to the most significant bits of a constellation (such as based on the systematic bits being included in the last quantity of bit locations within the codeword), which may improve a block error rate of the systematic bits as compared to other systematic polar encoding operations (where the systematic bits are not included in the last quantity of bit locations of the codeword). In some cases, mapping the first set of intermediate bits to the bottom portion of the second polar matrix may cause the systematic bits to be included in the last quantity of bit locations within the codeword.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

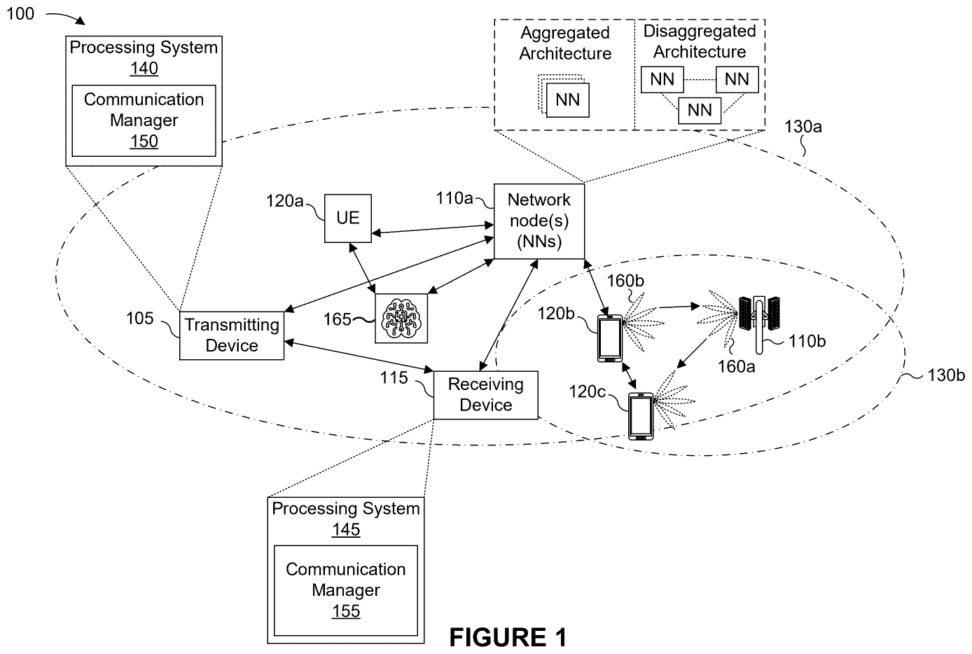

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

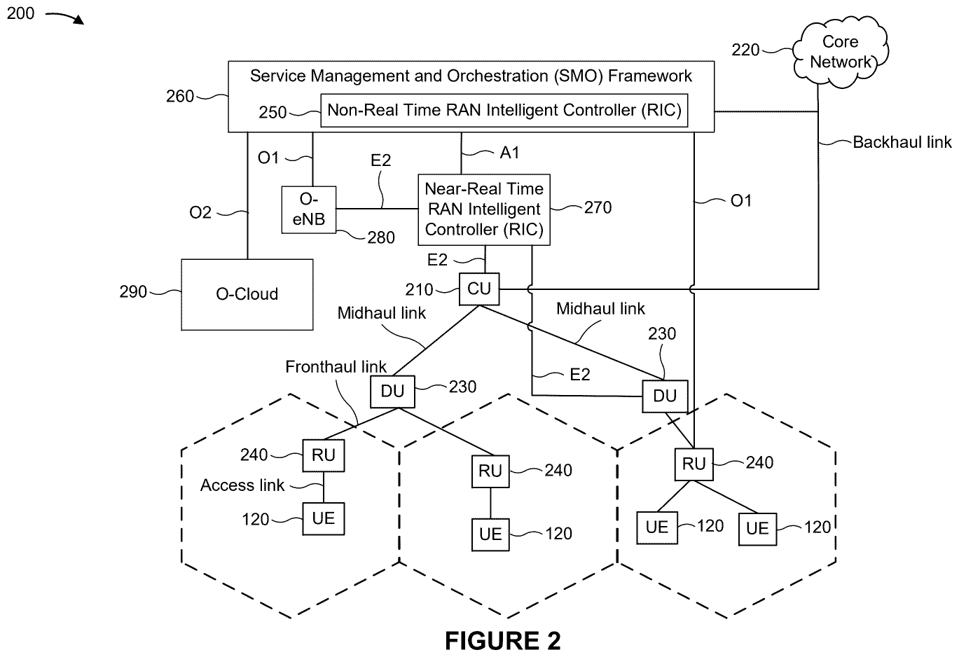

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, in accordance with a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move in accordance with the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified in accordance with different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) in accordance with changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi-co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, in accordance with a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples.

In the wireless communication network 100, information may be represented as a sequence of binary bits that are mapped (for example, modulated) to an analog signal waveform that is transmitted to a receiver over a wireless communication channel. In some cases, however, the wireless communication channel may introduce errors that corrupt the transmitted signal due to random noise, interference, device impairments, and/or other factors. At the receiver, the received signal (that may have been corrupted during transmission) is mapped back to binary bits, with the received binary information estimating the transmitted binary information. Accordingly, because errors may corrupt the signal that is estimated at the receiver, channel coding or forward error correction (FEC) techniques are often used to control errors in data transmission over unreliable or noisy communication channels or otherwise mitigate the bit errors that may occur due to noise, interference, and/or other factors. For example, channel coding generally includes an encoding operation performed at a transmitter (for example, a first wireless device, which may be a UE 120 or a network node 110) and a decoding operation performed at a receiver (for example, a second wireless device, which may be a UE 120 or a network node 110). Channel coding is generally accomplished by selectively introducing redundancy into the transmitted information stream, typically using an error correction code (ECC), which allows the receiver to detect errors and/or correct bit errors in the received data stream and thereby provide more reliable information transmission. Accordingly, channel codes are often used in scenarios where retransmissions are undesirable and/or high transmission reliability is needed, such as downlink and/or uplink control channel communications.

For example, in some cases, the wireless communication network 100 may use polar codes to implement channel coding for downlink and/or uplink control channel communications. More particularly, polar coding is a linear block coding technique that has provable capacity-achieving performance over binary channels with polynomial complexity in various scenarios (such as channel coding, among others). Polar coding has a built-in channel polarization structure that uses a recursive construction to split (or “polarize”) a communication channel into reliable subchannels that are very good for transmitting information and unreliable subchannels that are very bad for transmitting information. The reliable subchannels may be almost completely noiseless, with a capacity that approaches 1, and the unreliable subchannels may be almost completely noisy, with a capacity that approaches 0. During polar encoding, a polar transform is applied to assign information bits to the reliable subchannels and to assign “frozen” or “fixed” bits (for example, “0” bits) to the unreliable subchannels. For example, a polar code with a rate R=K/N may be defined in accordance with a set of parameters {N, K, G_{N}, A}, where N is a code block length with N=2ⁿ, for n≥1, K is a code dimension, A is a data index set, A⊂{1, 2, . . . , N} with size |A|=K, and G_{N} is a polar transform defined by:

$${G}_{2} = [ \begin{matrix}1 & 0 \\ 1 & 1\end{matrix} ] , {G}_{N} = [ \begin{matrix}{G}_{N / 2} & 0 \\ {G}_{N / 2} & {G}_{N / 2}\end{matrix} ] = {G}_{2}^{⊗ n}$$

Given a data block d=(d₁, . . . , d_{K}), a polar code with the parameters {N, K, G_{N}, A} encodes the data block d in two steps, where the first step is to construct a transform input block u=(u₁, . . . , u_{N}) by setting:

$${u}_{A} {=}^{Δ} ( {u}_{i} : i ∈ A ) = d , {u}_{{A}^{C}} {=}^{Δ} ( {u}_{i} : i ∈ {A}^{C} ) = 0$$

and the second step is to compute the code block x by computing the polar transform of u, where x=uG_{N}. Accordingly, polar codes have an encoding/decoding complexity given by N log N, a construction complexity that is roughly O(N), and a block error probability that approaches zero roughly as 2^{-\sqrt{N}} for any fixed rate R that is less than a channel capacity (for example, there is no error floor).

In some aspects, a first device may correspond to a transmitting device 105, which may also be referred to as an encoding device. The transmitting device may be a UE 120 or a network node 110. Additionally, the transmitting device may include a communication manager 150. As described in more detail elsewhere herein, the communication manager 150 may perform a first polar encoding operation on a set of information bits to obtain a first set of intermediate bits; map the first set of intermediate bits contiguously to a second polar encoding operation; perform the second polar encoding operation on the first set of intermediate bits and a second set of intermediate bits to obtain a systematically polar encoded codeword; and transmit the systematically polar encoded codeword to a second device, wherein the systematically polar encoded codeword comprises a contiguous set of encoded bits corresponding to the set of information bits and one or more additional encoded bits. Additionally, or alternatively, the communication manager 150 may perform one or more other operations described herein.

In some aspects, the first device may correspond to a receiving device 115, which may also be referred to as a decoding device. The receiving device may be a UE 120 or a network node 110. Additionally, the receiving device may include a communication manager 155. As described in more detail elsewhere herein, the communication manager 155 may receive, from a second device, a systematically polar encoded codeword comprising a contiguous set of encoded bits corresponding to a set of information and one or more additionally encoded bits; perform a first polar decoding operation on the systematically polar encoded codeword to obtain a first set of intermediate bits and a second set of intermediate bits; map the second set of intermediate bits contiguously to a second polar decoding operation; and perform the second polar decoding operation on the second set of intermediate bits to obtain the set of information bits. Additionally, or alternatively, the communication manager 155 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

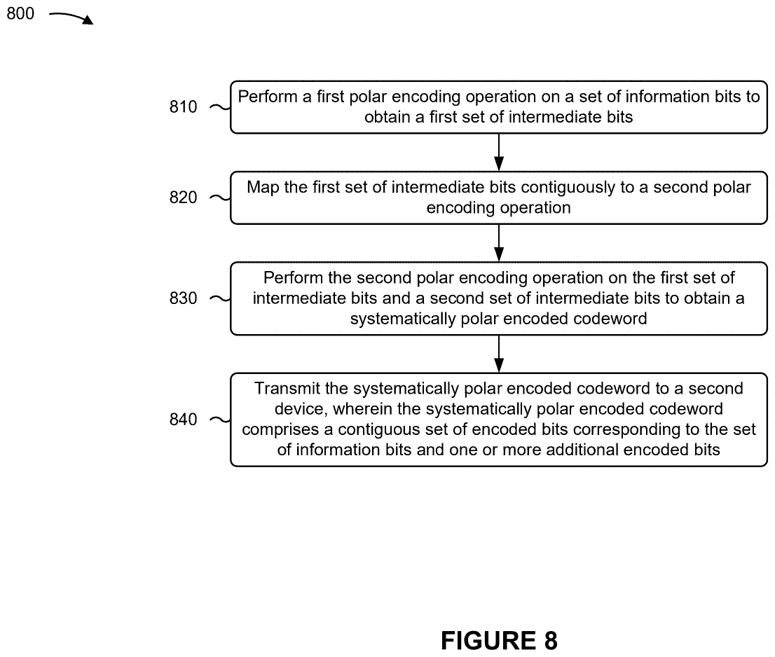

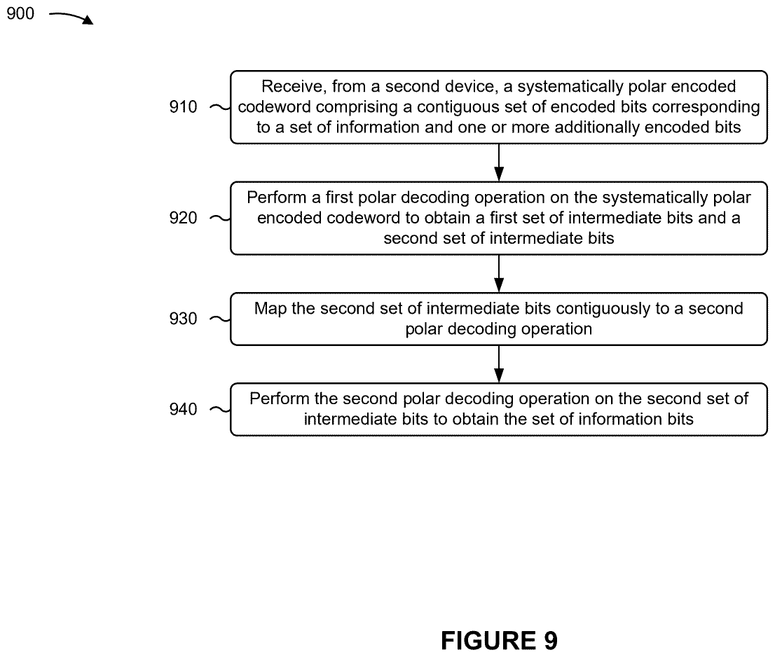

The network node 110, the receiving device 115, the processing system 145 of the receiving device 115, the UE 120, the transmitting device 105, the processing system 140 of the receiving device 115, the CU 210, the DU 230, the RU 240, or any other component(s) of FIG. 1 and/or FIG. 2 may implement one or more techniques or perform one or more operations associated with systematic polar encoding operations, as described in more detail elsewhere herein. For example, the processing system 145 of the receiving device 115, the processing system 140 of the transmitting device 105, the CU 210, the DU 230, or the RU 240 may perform or direct operations of, for example, process 800 of FIG. 8, process 900 of FIG. 9, or other processes as described herein (alone or in conjunction with one or more other processors). In some aspects, the transmitting device 105 and/or the receiving device 115 is a network node 110, a UE 120, or another wireless communication device. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

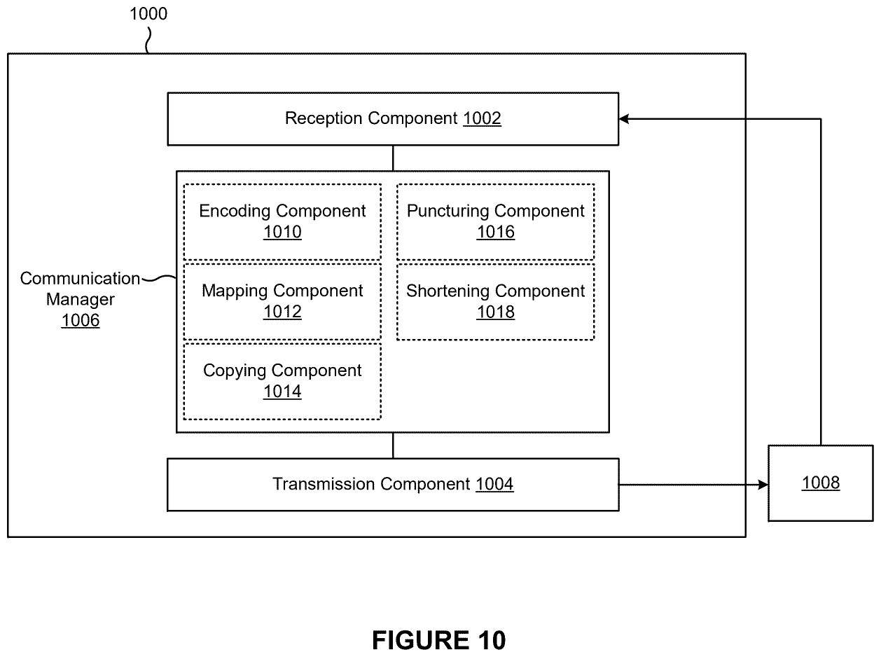

In some aspects, the transmitting device 105 includes means for performing a first polar encoding operation on a set of information bits to obtain a first set of intermediate bits; means for mapping the first set of intermediate bits contiguously to a second polar encoding operation; means for performing the second polar encoding operation on the first set of intermediate bits and a second set of intermediate bits to obtain a systematically polar encoded codeword; and/or means for transmitting the systematically polar encoded codeword to a second device, wherein the systematically polar encoded codeword comprises a contiguous set of encoded bits corresponding to the set of information bits and one or more additional encoded bits. In some aspects, the means for the transmitting device to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

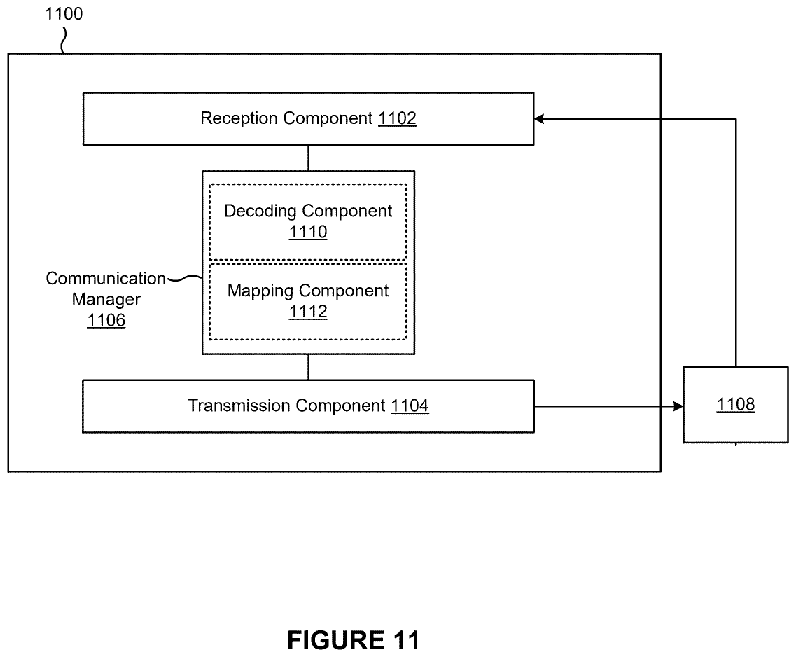

In some aspects, the receiving device 115 includes means for receiving, from a second device, a systematically polar encoded codeword comprising a contiguous set of encoded bits corresponding to a set of information and one or more additionally encoded bits; means for performing a first polar decoding operation on the systematically polar encoded codeword to obtain a first set of intermediate bits and a second set of intermediate bits; means for mapping the second set of intermediate bits contiguously to a second polar decoding operation; and/or means for performing the second polar decoding operation on the second set of intermediate bits to obtain the set of information bits. In some aspects, the means for the receiving device to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

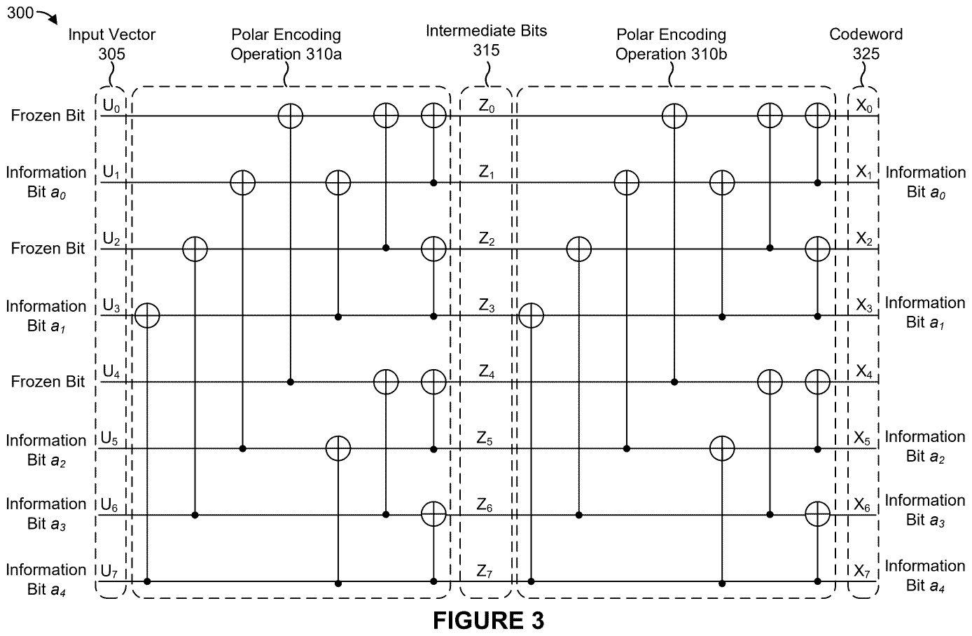

FIG. 3 is a diagram illustrating an example of a systematic polar encoding operation 300 in accordance with the present disclosure. In some cases, a transmitting device 105 (such as a UE 120 or a network node 110) may perform the systematic polar encoding operation 300 to generate a systematically polar encoded codeword 325.

In this example, the systematic polar encoding operation 300 is an 8-bit encoding operation, and therefore receives an input vector 305 having a length N=8. Using this information, the systematic polar encoding operation 300 outputs an 8-bit codeword X ([X₀, X₁, . . . , X₇]). Systematic polar encoders of other bit sizes may also be used and in some cases, the output codeword 325 may have a different length than that of the input vector 305.

In the example systematic polar encoding operation 300, the input vector 305 may include a plurality of bits to be encoded, at least a portion of which may be information bits. For example, the information bit a₀ is input to the bit channel U₁, the information bit a₁ is input to the bit channel U₃, the information bit a₂ is input to the bit channel U₅, the information bit a₃ is input to the bit channel U₆, and the information bit a₃ is input to the bit channel U₇. The bit channels U that do not receive an information bit input may receive a frozen bit input. Frozen bits may be specific bits in an encoded codeword (such as the codeword 325) or that are input to a polar encoding operation (such as the first polar encoding operation 310a or the second polar encoding operation 310b) that are set to a fixed value during the encoding process. That is, frozen bits may not carry information and may be reserved for error correction or detection. The frozen bits may, in some cases, be set to ‘0’ or some other predetermined value. In some cases, the bit channels U that are associated with a lower reliability may receive a frozen bit input.

As shown, the bit channel U₀ may receive a frozen bit, and three Boolean exclusive or (XOR) operations are performed (represented by “+” symbol), and bit Z₀ of the intermediate bits 315 is obtained. As depicted, the systematic polar encoding operation 300 may perform zero or more operations on the bits input into each bit channel instance U₀ to U₇. Encoding a bit in one channel instance may depend on bits input to one or more other channel instances. For example, the bit channel U₆ encodes the information bit a₃ by XOR'ing the information bits a₃ an a₄ (Z₆=a₃ XOR a₄).

In some cases, the bit channel instances U_{N} (U₀-U₇) may each have an associated reliability metric. Thus, the information bits assigned bit locations U₀ to U₇ may have varying probabilities of successful decoding once the codeword 325 is transmitted and received at a receiver. In such cases, the input bits input to the ‘k’ most reliable channel instances may be assigned an information bit type.

To perform the example systematic polar encoding operation 300, a device (such as a transmitting device or an encoding device) may perform, in accordance with a polar matrix, a first polar encoding operation 310a on a set of information bits input to a subset of the bit channels U ([U₁, U₂, . . . U₇]) of the systematic polar encoding operation 300 to obtain a set of intermediate bits 315 that include Z ([Z₁, Z₂, . . . , Z₇]) and performing, in accordance with the polar matrix, a second polar encoding operation 310b on the set of intermediate bits 315 to obtain the codeword 325. That is, the device may perform the systematic polar encoding operation 300 by performing a non-systematic polar encoding operation twice (such as the polar encoding operation 310a and the polar encoding operation 310b). In the example systematic polar encoding operation 300, the first and second polar encoding operations 310 may be based on the same polar matrix. That is, the systematic polar encoding operation 300 is performed based on the polar transform G (such as the polar transform G that is associated with the first polar encoding operation 310a and the second polar encoding operation 310b). In some cases, the polar transform G may be an involution such that G*G=I, which may cause the resulting codeword 325 to be a systematically polar encoded codeword.

In the example systematic polar encoding operation 300, a location of the systematic bits in the codeword 325 (that correspond to the set of information bits) may be the same as the location of the set of information bits in a U-domain (corresponding to the input vector 305). That is, the systematic bits in the codeword 325 may be within the k most reliable bit channels. Accordingly, the location of the systematic bits in the codeword 325 may be based on the polar sequence design. To decode the systematically polar encoded codeword 325, a receiving device may also perform two polar decoding operations in accordance with the same polar matrix. For example, the receiving device may perform a first polar decoding operation to decode the codeword 325 with a decoder (such as a successive cancellation list (SCL) decoder) and obtain the intermediate bits 315 in the Z domain ([Z₁, Z₂, . . . , Z₇]). Then, the receiving device may convert the intermediate bits to the U domain to obtain the information bits via a second polar decoding operation.

But performing the systematic polar encoding operation 300 based on performing a non-systematic polar encoding operation twice (such as the polar encoding operation 310) may increase an encoding complexity and an encoding latency as compared to non-systematic polar encoding operations (such as twofold). Additionally, the systematic polar encoding operation 300 may be associated with an increased complexity and latency as compared to the non-systematic polar encoding operation (such as due to the receiving device performing two polar decoding operations). Accordingly, non-systematic polar codes may be associated with decreased complexity and latency as compared to systematic polar codes. Further, the systematic polar encoding operation 300 generates a codeword 325 where the locations of the systematic bits (corresponding to the information bits a) may be dependent on the construction of the polar code (such as dependent on the reliability sequence of the polar code). That is, the locations of the systematic bits may not be fixed. Accordingly, a receiving device may be unable to exploit a fixed location of the systematic bits to improve performance (such as for QAM, systematic bit prioritization mapping, for joint source and channel coding). Additionally, the locations of the systematic bits not being fixed may increase a complexity of LLR generation, as the locations of the systematic bits and CRC bits are not fixed and the receiving device would have to determine the locations of the systematic bits and the CRC bits to perform the LLR generation by looking up the polar code sequence.

But some devices may still communicate systematically polar encoded codewords. That is, systematic polar codes may be associated with improved bit error rates as compared to non-systematic polar codes. Additionally, systematic polar codes may enable a transmitting device to more effectively exploit side information about a source as compared to non-systematic polar codes. That is, systematic polar codes may enable a transmitting device to perform joint source channel coding, which may improve a data driven system and coding design.

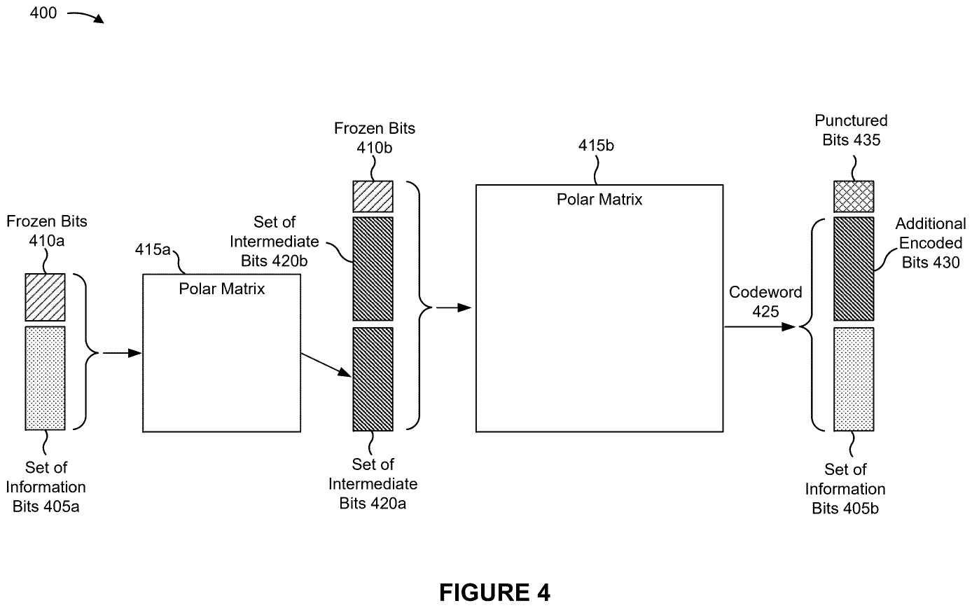

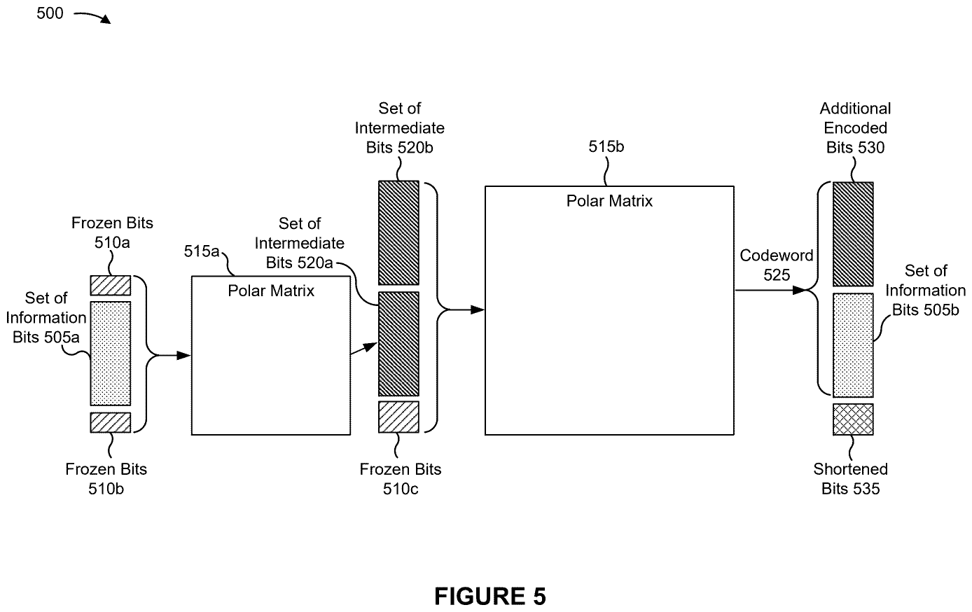

As described herein, and illustrated with respect to FIGS. 4 and 5, a device (such as a transmitting device or an encoding device) may perform a systematic polar encoding operation that is less complex and introduces less latency as compared to the example systematic polar encoding operation 300.

FIG. 4 is a diagram illustrating an example of a systematic polar encoding operation 400 in accordance with the present disclosure. In the example systematic polar encoding operation 400, a device (such as a transmitting device or an encoding device) may perform the systematic polar systematic polar encoding operation 400 on a set of information bits 405a to obtain a codeword 425 that includes a contiguous set of bits corresponding to the set of information bits 405b.

To perform the systematic polar encoding operation 400, the device may perform a first polar encoding operation in accordance with a first polar matrix 415a. The first polar matrix 415a may be a lower triangular matrix. The device may perform the first polar encoding operation on a set of information bits 405a. The set of information bits 405a may include K information bits, which may also include CRC. For example, the set of information bits 405a may correspond to an input vector u=[u₀, . . . , u_{K-1}]. The size of the first polar matrix 415a may be based on the quantity of bits in the set of information bits 405a. For example, the size M₁ of the polar matrix 415a may be M₁=2^{┌log}^{₂} ^{K┐}. That is, the size M₁ of the first polar matrix 415a may be equal to a smallest integer that is a power of 2 and that is larger than K. In the example systematic polar encoding operation 400, the size M₁ of the first polar matrix 415a may be larger than the quantity of bits K in the set of information bits 405a. Accordingly, the device may also input a set of frozen bits 410a to the polar matrix 415a. The quantity of bits in the frozen bits 410a may correspond to (M₁−K). The device may input the set of frozen bits 410a to the top of the polar matrix 415a (such as to a subset of indices of the polar matrix 415a that are smaller than a remaining quantity of indices of the polar matrix 415a) based on performing a puncturing operation (such as to remove the punctured bits 435) to obtain the codeword 425.

The device may perform the first polar encoding operation on the set of information bits 405a and the frozen bits 410a to obtain the set of intermediate bits 420a. The first polar encoding operation may generate M₁ bits, and the M₁ bits may include the K bits in the set of intermediate bits 420a. In particular, the first polar encoding operation may generate more bits than are included in the set of intermediate bits 420a (M₁>K), and the set of intermediate bits 420a may include the last K bits within the generated M₁ bits. The systematic polar encoding operation 400 may additionally include a second polar encoding operation that is in accordance with a second polar matrix 415b that is larger than the first polar matrix 415a. Therefore, the device may generate an additional set of intermediate bits 420b prior to performing the second polar encoding operation on the set of intermediate bits 420a. That is, the size M₂ of the polar matrix 415b may be M₂=2^{┌log}^{₂} ^{K┐}, where N corresponds to the quantity of bits in the codeword 425. Here, the device may add M₂−K bits to the K bits in the set of intermediate bits 420a to input to the second polar encoding operation that is associated with the polar matrix 415b.

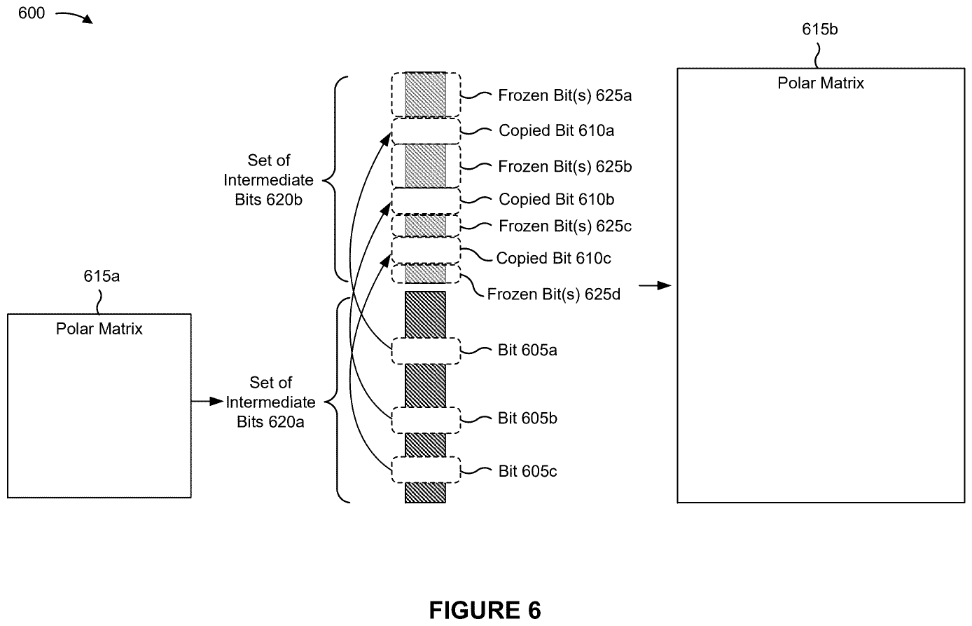

The M₂−K bits may include a second set of intermediate bits 420b and one or more frozen bits 410b. The device may generate the second set of intermediate bits 420b based on the set of intermediate bits 420a. The process of generating the second set of intermediate bits 420b is described in more detail with respect to FIG. 6.

The device may map the first set of intermediate bits 420a, the second set of intermediate bits 420b, and the frozen bits 410b to the polar matrix 415b. The second polar matrix 415b may be a lower triangular matrix. The device may map the set of intermediate bits 420a contiguously to a first subset of indices of the polar matrix 415b. In particular, the device may map the set of intermediate bits 420a to the subset of indices of the polar matrix 415b that are larger than indices that are not in the first subset (such as to the subset of indices that correspond to a bottom portion of the polar matrix 415b). The device may map the set of intermediate bits 420b contiguously to a second subset of indices of the polar matrix 415b. In particular, the device may map the set of intermediate bits 420b to a subset of indices of the polar matrix 415b that are smaller than indices that are in the first subset (such as to the subset of indices that correspond to an upper portion of the polar matrix 415b than the first subset of indices). Additionally, the device may map the set of frozen bits 410b to a third subset of indices of the polar matrix 415b. In the example systematic polar encoding operation 400, the device may perform a puncturing operation on the set of encoded bits obtained based on performing the second polar encoding operation (such as the polar encoding operation that is in accordance with the polar matrix 415b). Based on the device performing the puncturing operation, the device may map the frozen bits 410b to the indices of the polar matrix 415b that are smaller than the indices within the first and second subsets (such as to the subset of indices that correspond to the topmost portion of the polar matrix 415b).

The device may perform the second polar encoding operation on the set of frozen bits 410b, the set of intermediate bits 420a, and the set of intermediate bits 420b to obtain the codeword 425. The codeword 425 may include a contiguous set of bits that correspond to the systematic bits within the codeword 425 and include the set of information bits 405b. That is, the set of information bits 405b may include the same bits as the set of information bits 405a and may appear in the same order as the set of information bits 405a. In the example systematic polar encoding operation 400, the last K bits in the codeword 425 may include the systematic bits (such as the set of information bits 405b). That is, the location of the systematic bits in the codeword may be fixed to be the last K bits in the codeword 425. The codeword 425 may also include one or more additional encoded bits 430. The quantity of bits in the additional encoded bits 430 may correspond to N−K bits.

In the example systematic polar encoding operation 400, the device may additionally puncture one or more bits obtained by the second polar encoding operation. For example, the device may remove the punctured bits 435 to obtain the codeword 425. In some cases, the device may perform the puncturing operation based on the output of the second polar encoding operation overlapping with another RAT (such as within a dynamic superposition set). Here, the systematic bits within the codeword 425 that include the set of information bits 405b being within the last K bits of the codeword 425 may protect the systematic bits from being punctured (such as by not puncturing them via resource mapping). Additionally, in a case of systematic bit prioritization mapping, mapping the systematic bits to the last K bits of the codeword 425 (such as to the most significant bits of the constellation) may improve a bit error rate of the systematic bits as compared to a bit error rate of the systematic bits in the codeword 325.

The example systematic polar encoding operation 400 may be less complex than a systematic polar encoding operation that includes two polar encoding operations that are in accordance with two polar matrices that are a same size. That is, to obtain a codeword with N bits, the two polar matrices would both have to be a length N. However the polar matrix 415a has a length of approximately K which may be smaller than N (such as based on a code rate associated with the systematic polar encoding operation 400).

FIG. 5 is a diagram illustrating an example of a systematic polar encoding operation 500 in accordance with the present disclosure. In the example systematic polar encoding operation 500, a device (such as a transmitting device or an encoding device) may perform the systematic polar systematic polar encoding operation 500 on a set of information bits 505a to obtain a codeword 525 that includes a contiguous set of bits corresponding to the set of information bits 505b.

The example systematic polar encoding operation 500 illustrates a systematic polar encoding operation that includes a shortening operation. The device may determine to perform the shortening operation based on a code rate associated with the systematic polar encoding operation 500. For example, the device may perform the shortening operation (such as instead of a puncturing operation) if the code rate is larger (such as if K/N>½). In some other examples, if the device determines that the code rate is larger (such as if K/N>½), the device may instead perform a systematic polar encoding operation as described with reference to FIG. 3.

To perform the systematic polar encoding operation 500, the device may perform a first polar encoding operation in accordance with a first polar matrix 515a. The first polar matrix 515a may be a lower triangular matrix. The device may perform the first polar encoding operation on a set of information bits 505a. The set of information bits 505a may include K information bits, which may also include CRC. For example, the set of information bits 505a may correspond to an input vector u=[u₀, . . . , u_{K-1}]. The size of the first polar matrix 515a may be based on the quantity of bits in the set of information bits 505a. For example, the size M₁ of the polar matrix 515a may be M₁=2^{┌log}^{₂} ^{K┐}. In the example systematic polar encoding operation 500, the size M₁ of the first polar matrix 515a may be larger than the quantity of bits K in the set of information bits 505a. Accordingly, the device may also input a set of frozen bits 510a and 510b to the polar matrix 515a. The quantity of bits in the frozen bits 510a and 510b may correspond to (M₁−K). The device may input the frozen bits 510b to the bottom of the polar matrix 515a (such as to the larger indices of the polar matrix 515a) based on performing the shortening operation. That is, the frozen bits 510b may correspond to the shortening bits. In some cases, the quantity of bits in the frozen bits 510b may correspond to M₂−N and the quantity of bits in the frozen bits 510a may correspond to M₁−K+N−M₂.

The device may perform the first polar encoding operation on the set of information bits 505a and the frozen bits 510a to obtain the set of intermediate bits 520a. The device may generate an additional set of intermediate bits 520b prior to performing the second polar encoding operation on the set of intermediate bits 520a. For example, the device may generate N−K bits in the set of intermediate bits 520b to input to the second polar encoding operation that is associated with the polar matrix 515b. The device may generate the second set of intermediate bits 520b based on the set of intermediate bits 520a. The process of generating the second set of intermediate bits 520b is described in more detail with respect to FIG. 6.

The device may map the first set of intermediate bits 520a, the second set of intermediate bits 520b, and the frozen bits 510c to the polar matrix 515b. The second polar matrix 515b may be a lower triangular matrix. The frozen bits 510c may correspond to the shortened bits 535, and accordingly the device may map the frozen bits 510c to the largest indices of the polar matrix 515b. The device may map the set of intermediate bits 520a contiguously to a first subset of indices of the polar matrix 515b. The device may map the set of intermediate bits 520b contiguously to a second subset of indices of the polar matrix 515b. In particular, the device may map the set of intermediate bits 520b to a subset of indices of the polar matrix 515b that are smaller than indices that are in the first subset (such as to the subset of indices that correspond to an upper portion of the polar matrix 515b than the first subset of indices).

The device may perform the second polar encoding operation on the set of frozen bits 510c, the set of intermediate bits 520a, and the set of intermediate bits 520b to obtain the codeword 525. The codeword 525 may include a contiguous set of bits that correspond to the systematic bits within the codeword 525 and include the set of information bits 505b. That is, the set of information bits 505b may include the same bits as the set of information bits 505a and may appear in the same order as the set of information bits 505a. In the example systematic polar encoding operation 500, the last K bits in the codeword 525 may include the systematic bits (such as the set of information bits 505b). That is, the location of the systematic bits in the codeword may be fixed to be the last K bits in the codeword 525. The codeword 525 may also include one or more additional encoded bits 530. The quantity of bits in the additional encoded bits 530 may correspond to N−K bits.

In the example systematic polar encoding operation 500, the device may additionally shorten one or more bits obtained by the second polar encoding operation. For example, the device may remove the shortened bits 535 to obtain the codeword 525.

FIG. 6 is a diagram illustrating an example process 600 for generating a set of intermediate bits 620b in accordance with the present disclosure. In some cases, a device that is performing the systematic polar encoding operations 400 and 500 illustrated with respect to FIGS. 4 and 5 may perform the process 600 to generate the set of intermediate bits (such as the set of intermediate bits 420b or the set of intermediate bits 520b). The polar matrix 615a may be an example of the polar matrix 415a or the polar matrix 515a and the polar matrix 615b may be an example of the polar matrix 415b or the polar matrix 515b.

The set of intermediate bits 620a may correspond to a set of bits that are obtained by a device (such as a transmitting device or an encoding device) based on performing a first polar encoding operation in accordance with the polar matrix 615a. Additionally, the device may input the set of intermediate bits 620a and the set of intermediate bits 620b to a second polar encoding operation in accordance with the polar matrix 615b.

The set of intermediate bits 620a may correspond to a set of intermediate bits Z₁=\tilde{G}₁u, where \tilde{G}₁ denotes the submatrix of the first polar matrix 615a containing only the last K rows of the first polar matrix G₁. To generate the second set of intermediate bits 620b, the device may copy a subset of the bits from the first set of intermediate bits 620a. For example, the device may copy the bit 605a to generate the copied bit 610a, copy the bit 605b to generate the copied bit 610b, and copy the bit 605c to generate the copied bit 610c.

In some cases, the device may determine the locations of the bits 605 to copy within the set of intermediate bits 620a based on the polar sequence length M₂. The device may determine to copy the bits within the set of intermediate bits 620a that correspond to the frozen bit locations associated with the polar matrix 615b. For example, the device may determine a set of indices A within the set of intermediate bits 620a that do not correspond to information bits within the second polar encoding operation. Instead, the set of indices A may correspond to the frozen bit locations within the polar matrix 615b. That is, A may contain the bits within the set of intermediate bits 620a that, when mapped contiguously to the last subset of indices within the polar matrix 615b, are mapped to frozen bits of the polar code of length N. The bits in the set of A from the bit sequence z₁ (such as the bit 605a, the bit 605b, and the bit 605c) may be copied to the set of intermediate bits 620b.

Then the device may map the copied bits 610 to indices of the second polar matrix 615b. The device may map the copied bits 610 to the indices of the second polar matrix 615b that are associated with information bit locations (instead of frozen bit locations). The device may map the copied bits 610 to a set of indices B of the polar matrix 615b, and the set of indices B may correspond to the information bit locations within the first N−K bit locations of the polar matrix 615b. For example, the device may map the copied bits 610 to the information bit locations of the polar matrix 615b that are within the first N−K bits of an (N, K) polar code. A quantity of indices within the set of indices A (that is associated with the first set of intermediate bits 620a that are copied) and a quantity of indices within the set of indices B (that is associated with the second set of intermediate bits 620b that include the copied bits 610) may be equal. That is, a cardinality of the set of indices A and the set of indices B may be equal. By mapping the copied bits 610 to the indices of the second polar matrix 615b that correspond to information bit locations, the device may map information bits (such as non-frozen bits) to each of the information bit locations of the second polar matrix 615b.

To generate the set of intermediate bits 620b, the device may additionally fill a remaining quantity of indices within the first N−K bit locations of the polar matrix 615b with frozen bits. For example, the device may fill the initial bit locations within the polar matrix 615b (such as the bit locations that correspond to the punctured bit locations) with the frozen bits 625a. Additionally, the device may add the frozen bits 625b, the frozen bits 625c, and the frozen bits 625d to the set of intermediate bits 620b. Thus, the device may generate the set of intermediate bits 620b such that the set of intermediate bits 620b includes a set of copied bits 610 and a set of frozen bits 625. In some cases, one or more of the frozen bits 625 may mapped to indices of the polar matrix 615b that are associated with frozen bit locations within the polar matrix 615b.

Then, the device may perform a second encoding operation on the first set of intermediate bits 620a and the second set of intermediate bits 620b to obtain a systematically polar encoded codeword. In some cases, the systematically polar encoded codeword (e.g., prior to a puncturing or shortening operation) may be

$${G}_{2} \cdot {[ \begin{matrix}{z}_{2} \\ {z}_{1}\end{matrix} ]}^{T} ,$$

where z₂ and z₁ are column vectors that correspond to the second set of intermediate bits 620b and the first set of intermediate bits 620a, respectively.

A receiving device (such as a device that receives the systematically polar encoded codeword) may perform one or more polar decoding operations to obtain the set of information bits. For example, the receiving device may perform a first polar decoding operation, corresponding to the polar matrix 615b, on the systematically polar encoded codeword to obtain the set of intermediate bits 620b and the set of intermediate bits 620a. In some cases, the first polar decoding operation may correspond to SCL decoding (such as an SCL decoding operation used to decode non-systematically polar encoded codewords). Here, the receiving device may successively decode each of the information bits corresponding to information bit locations of the polar matrix 615b (such as the copied bits 610 within the set of intermediate bits 620b and the bits 605 in the set of intermediate bits 620a). For the first polar decoding operation, the receiving device may treat the copied bits 610a within the set of intermediate bits 620b as information bits.

When the receiving device decodes the information bits within the set of intermediate bits 620b, the receiving device may then (such as during the first polar decoding operation) copy back the copied bits 610 to the set of intermediate bits 620a. That is, the receiving device may obtain the set of intermediate bits 620b based on performing an SCL decoding operation on the systematically polar encoded codeword. Then, the receiving device may generate the set of intermediate bits 620a based on copying the information bits from the set of intermediate bits 620b (such as the copied bits 610 which are the bits within the set of intermediate bits 620b corresponding to information bit locations in the polar matrix 615b). Because the receiving device knows the values of the bits 605 within the set of intermediate bits 620a (such as based on performing the SCL decoding operation to obtain the copied bits 610 that are the same as the bits 605), the receiving device may perform an SCL decoding operation to obtain the set of intermediate bits 620a where the bits 605 are frozen bits (such as dynamic frozen bits, where the receiving device knows the values of the bits 605, but the known values of the bits 605 are not necessarily zero).

The receiving device may optionally terminate the polar decoding of the systematically polar encoded codeword early (such as without performing a second polar decoding operation, corresponding to the polar matrix 615a, on the set of intermediate bits 620a). For example, the receiving device may check the CRC bits included in the systematically polar encoded codeword, and if the CRC passes (that is if the receiving device does not detect any errors during the CRC using the channel LLR), the receiving device may terminate the decoding operation early. Alternatively (such as if the CRC does not pass), the receiving device may perform a second polar decoding operation, corresponding to the polar matrix 615a, on the first set of intermediate bits 620a to obtain the set of information bits.

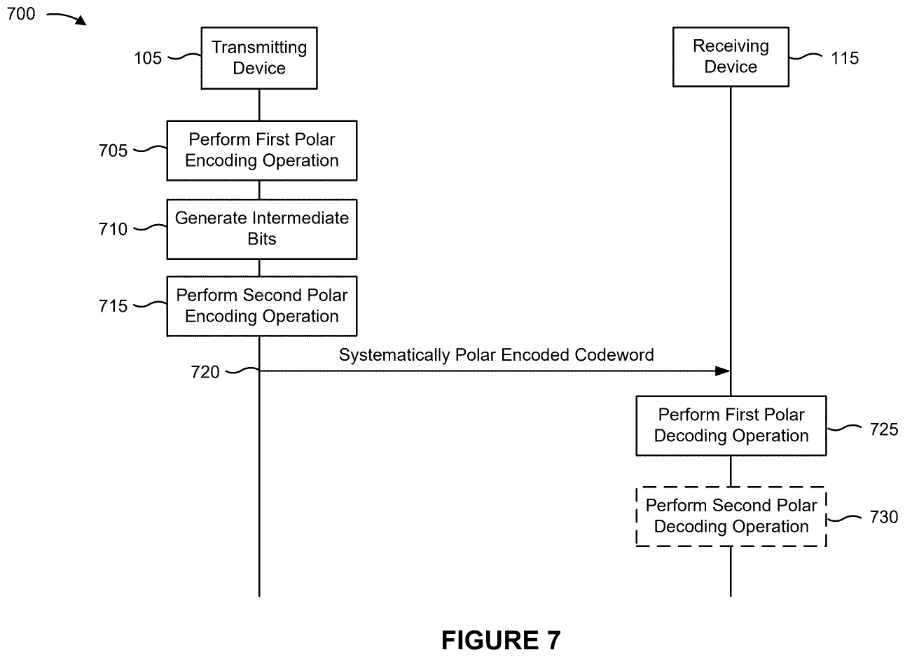

FIG. 7 is an example of a process flow 700 that supports systematic polar encoding operations in accordance with the present disclosure. As shown in FIG. 7, a transmitting device 105 and a receiving device 115 may communicate with one another. In some cases, the transmitting device 105 may perform the systematic polar encoding operations as described with reference to FIGS. 3 and 4.

At 705, a transmitting device 105 may perform a first polar encoding operation. For example, the transmitting device may perform the first polar encoding operation on a set of information bits to obtain a first set of intermediate bits, as described herein.

At 710, the transmitting device 105 may generate a set of intermediate bits. For example, the transmitting device 105 may copy a subset of the first set of intermediate bits to generate a second set of intermediate bits. In some cases, the second set of intermediate bits may include the copied subset of the first set of intermediate bits and one or more frozen bits.

At 715, the transmitting device 105 may perform a second polar encoding operation. In particular, the transmitting device may perform the second polar encoding operation on the first set of intermediate bits and the second set of intermediate bits to obtain a systematically polar encoded codeword. The systematically polar encoded codeword may include a contiguous set of encoded bits that correspond to the set of information bits (such as a set of systematic bits) and one or more additional encoded bits. In some cases, the transmitting device 105 may additionally perform a puncturing procedure (such as to remove one or more of the least significant bits generated by the second polar encoding operation) or a shortening procedure (such as to remove one or more of the most significant bits generated by the second polar encoding operation) to obtain the systematically polar encoded codeword.

At 720, the transmitting device 105 may transmit, and the receiving device 115 may receive, the systematically polar encoded codeword.

At 725, the receiving device 115 may perform a first polar decoding operation. For example, the receiving device 115 may perform a first polar decoding operation (such as a polar decoding operation that is in accordance with a same polar matrix as the polar encoding operation performed by the transmitting device 105 at 715) on the systematically polar encoded codeword received at 720 to obtain a first set of intermediate bits. In some cases, the first polar decoding operation may correspond to SCL decoding (such as an SCL decoding operation used to decode non-systematically polar encoded codewords). Here, the receiving device 115 may successively decode each of the information bits corresponding to information bit locations of the polar matrix within the first set of intermediate bits.

When the receiving device 115 decodes the information bits within the first set of intermediate bits, the receiving device 115 may then (such as during the first polar decoding operation) copy back the information bits within the first set of intermediate bits to generate a second set of intermediate bits. For example, the receiving device 115 may obtain the first set of intermediate bits based on performing an SCL decoding operation on the systematically polar encoded codeword. Then, the receiving device 115 may generate the second set of intermediate bits based on copying the information bits from the first set of intermediate bits that correspond to information bit locations. Because the receiving device 115 knows the values of the copied bits within the second set of intermediate bits, the receiving device 115 may perform an SCL decoding operation to obtain the second set of intermediate bits, where the copied bits are frozen bits (such as dynamic frozen bits, where the receiving device 115 knows the values of the copied bits, but the known values of the copied bits are not necessarily zero).

In some cases, to decode the systematically polar encoded codeword, the receiving device 115 may perform one or more decoding operations using a parity check polar decoder. That is, the receiving device 115 may check the CRC bits included in the systematically polar encoded codeword, and if the CRC passes (that is if the receiving device 115 does not detect any errors during the CRC using the channel LLR), the receiving device 115 may terminate the decoding operation early. For example, the receiving device 115 may refrain from performing any further decoding operations (such as the decoding operation described with reference to 730). If the receiving device 115 terminates the decoding operation early, the parity check (such as the CRC using the channel LLR) may correspond to a copying operation, which may be relatively simple and may not significantly increase a complexity of the decoding operation as compared to polar decoding operations.

If the receiving device 115 is unable to terminate the decoding early, the receiving device 115 may perform the second polar decoding operation at 730. For example, the receiving device 115 may map the second set of intermediate bits contiguously to the second polar decoding operation.

At 730, the receiving device 115 may optionally perform the second polar decoding operation (such as if the receiving device 115 is unable to terminate the polar decoding early). For example, the receiving device 115 may perform the second polar decoding operation on the second set of intermediate bits to obtain the set of information bits.

FIG. 8 is a flowchart illustrating an example process 800 performed, for example, at a first device (such as a transmitting device) or an apparatus of a first device that supports systematic polar encoding operations in accordance with the present disclosure. Example process 800 is an example where the apparatus or the first device (for example, a transmitting device 105) performs operations associated with a systematic polar encoding operation.

As shown in FIG. 8, in some aspects, process 800 may include performing a first polar encoding operation on a set of information bits to obtain a first set of intermediate bits (block 810). For example, the first device (such as by using communication manager 1006 or encoding component 1010, depicted in FIG. 10) may perform a first polar encoding operation on a set of information bits to obtain a first set of intermediate bits, as described above.

As further shown in FIG. 8, in some aspects, process 800 may include mapping the first set of intermediate bits contiguously to a second polar encoding operation (block 820). For example, the first device (such as by using communication manager 1006 or mapping component 1012, depicted in FIG. 10) may map the first set of intermediate bits contiguously to a second polar encoding operation, as described above.

As further shown in FIG. 8, in some aspects, process 800 may include performing the second polar encoding operation on the first set of intermediate bits and a second set of intermediate bits to obtain a systematically polar encoded codeword (block 830). For example, the first device (such as by using communication manager 1006 or encoding component 1010, depicted in FIG. 10) may perform the second polar encoding operation on the first set of intermediate bits and a second set of intermediate bits to obtain a systematically polar encoded codeword, as described above.

As further shown in FIG. 8, in some aspects, process 800 may include transmitting the systematically polar encoded codeword to a second device, wherein the systematically polar encoded codeword comprises a contiguous set of encoded bits corresponding to the set of information bits and one or more additional encoded bits (block 840). For example, the first device (such as by using communication manager 1006 or transmission component 1004, depicted in FIG. 10) may transmit the systematically polar encoded codeword to a second device, wherein the systematically polar encoded codeword comprises a contiguous set of encoded bits corresponding to the set of information bits and one or more additional encoded bits, as described above.

Process 800 may include additional aspects, such as any single aspect or any combination of aspects described below or in connection with one or more other processes described elsewhere herein.

In a first additional aspect, process 800 includes copying a subset of the first set of intermediate bits to generate the second set of intermediate bits, wherein the second set of intermediate bits comprises the copied subset of the first set of intermediate bits and a plurality of frozen bits.

In a second additional aspect, the subset of the first set of intermediate bits comprises bits in the first set of intermediate bits that correspond to frozen bit locations associated with the second polar encoding operation.

In a third additional aspect, process 800 includes mapping the first set of intermediate bits comprises mapping the first set of intermediate bits to a first set of indices of the second polar encoding operation, the method further comprises mapping the second set of intermediate bits to a second set of indices of the second polar encoding operation, and the first set of indices comprise larger indices of the second polar encoding operation than the second set of indices.

In a fourth additional aspect, a last quantity of bit locations within the systematically polar encoded codeword comprises the contiguous set of encoded bits corresponding to the set of information bits.

In a fifth additional aspect, process 800 includes the first polar encoding operation is in accordance with a first polar matrix having a first size, and the second polar encoding operation is in accordance with a second polar matrix having a second size that is different than the first size.

In a sixth additional aspect, process 800 includes puncturing one or more bits generated by performing the second polar encoding operation to obtain the systematically polar encoded codeword.

In a seventh additional aspect, process 800 includes mapping a subset of the second set of intermediate bits to one or more bit channels of the second polar encoding operation that correspond to the one or more bits that are punctured, wherein each bit in the subset of the second set of intermediate bits is a frozen bit.

In an eighth additional aspect, process 800 includes shortening one or more bits generated by performing the second polar encoding operation to obtain the systematically polar encoded codeword.

In a ninth additional aspect, process 800 includes performing the first polar encoding operation comprises performing the first polar encoding operation on the set of information bits and one or more frozen bits, and the one or more frozen bits are mapped to one or more bit channels of the second polar encoding operation that correspond to the one or more bits that are shortened.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, at a first device (such as a receiving device) or an apparatus of a first device that supports systematic polar encoding operations in accordance with the present disclosure. Example process 900 is an example where the apparatus or the first device (for example, the receiving device 115) performs operations associated with a systematic polar encoding operation.

As shown in FIG. 9, in some aspects, process 900 may include receiving, from a second device, a systematically polar encoded codeword comprising a contiguous set of encoded bits corresponding to a set of information and one or more additionally encoded bits (block 910). For example, the first device (such as by using communication manager 1106 or reception component 1102, depicted in FIG. 11) may receive, from a second device, a systematically polar encoded codeword comprising a contiguous set of encoded bits corresponding to a set of information and one or more additionally encoded bits, as described above.

As further shown in FIG. 9, in some aspects, process 900 may include performing a first polar decoding operation on the systematically polar encoded codeword to obtain a first set of intermediate bits and a second set of intermediate bits (block 920). For example, the first device (such as by using communication manager 1106 or decoding component 1110, depicted in FIG. 11) may perform a first polar decoding operation on the systematically polar encoded codeword to obtain a first set of intermediate bits and a second set of intermediate bits, as described above.

As further shown in FIG. 9, in some aspects, process 900 may include mapping the second set of intermediate bits contiguously to a second polar decoding operation (block 930). For example, the first device (such as by using communication manager 1106 or mapping component 1112, depicted in FIG. 11) may map the second set of intermediate bits contiguously to a second polar decoding operation, as described above.

As further shown in FIG. 9, in some aspects, process 900 may include performing the second polar decoding operation on the second set of intermediate bits to obtain the set of information bits (block 940). For example, the first device (such as by using communication manager 1106 or decoding component 1110, depicted in FIG. 11) may perform the second polar decoding operation on the second set of intermediate bits to obtain the set of information bits, as described above.

Process 900 may include additional aspects, such as any single aspect or any combination of aspects described below or in connection with one or more other processes described elsewhere herein.

In a first additional aspect, the second set of intermediate bits comprises a copied subset of the first set of intermediate bits and a plurality of frozen bits.

In a second additional aspect, the subset of the first set of intermediate bits comprises bits in the first set of intermediate bits that correspond to information bit locations associated with the first polar decoding operation.

In a third additional aspect, process 900 includes mapping the second set of intermediate bits comprises mapping the second set of intermediate bits from a first set of indices of the first polar decoding operation to the second polar decoding operation, and the first set of indices comprise larger indices of the first polar decoding operation than a second set of indices associated with the first set of intermediate bits.

In a fourth additional aspect, a last quantity of bit locations within the systematically polar encoded codeword comprises the contiguous set of encoded bits corresponding to the set of information bits.

In a fifth additional aspect, process 900 includes the first polar decoding operation is in accordance with a first polar matrix having a first size, and the second polar decoding operation is in accordance with a second polar matrix having a second size that is different than the first size.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram of an example apparatus 1000 for wireless communication that supports systematic polar encoding operations in accordance with the present disclosure. The apparatus 1000 may be a transmitting device, or a transmitting device may include the apparatus 1000. In some aspects, the apparatus 1000 includes a reception component 1002, a transmission component 1004, and a communication manager 1006, which may be in communication with one another (for example, via one or more buses). As shown, the apparatus 1000 may communicate with another apparatus 1008 (such as a UE 120, a network node 110, or another wireless communication device) using the reception component 1002 and the transmission component 1004. The communication manager 1006 may be included in, or implemented via, a processing system (for example, the processing system 140). In some aspects, the communication manager 1006 is the communication manager 150.

In some aspects, the apparatus 1000 may be configured to and/or operable to perform one or more operations described herein in connection with FIGS. 3-7. Additionally or alternatively, the apparatus 1000 may be configured to and/or operable to perform one or more processes described herein, such as process 800 of FIG. 8.

The reception component 1002 may receive communications, such as reference signals, control information, and/or data communications, from the apparatus 1008. The reception component 1002 may provide received communications to one or more other components of the apparatus 1000, such as the communication manager 1006. In some aspects, the reception component 1002 may perform signal processing on the received communications, and may provide the processed signals to the one or more other components in a similar manner as described above in connection with FIG. 1. In some aspects, the reception component 1002 may include one or more components of the first device described above in connection with FIG. 1, such as a radio, one or more RF chains, one or more transceivers, or one or more modems, each of which may in turn be coupled with one or more antennas of the first device.

The transmission component 1004 may transmit communications, such as reference signals, control information, and/or data communications, to the apparatus 1008. In some aspects, the communication manager 1006 may generate communications and may transmit the generated communications to the transmission component 1004 for transmission to the apparatus 1008. In some aspects, the transmission component 1004 may perform signal processing on the generated communications, and may transmit the processed signals to the apparatus 1008 in a similar manner as described above in connection with FIG. 1. In some aspects, the transmission component 1004 may include one or more components of the first device described above in connection with FIG. 1, such as a radio, one or more RF chains, one or more transceivers, or one or more modems, each of which may in turn be coupled with one or more antennas of the first device. In some aspects, the transmission component 1004 may be co-located with the reception component 1002.

The communication manager 1006 may perform a first polar encoding operation on a set of information bits to obtain a first set of intermediate bits. The communication manager 1006 may map the first set of intermediate bits contiguously to a second polar encoding operation. The communication manager 1006 may perform the second polar encoding operation on the first set of intermediate bits and a second set of intermediate bits to obtain a systematically polar encoded codeword. The communication manager 1006 may transmit or may cause the transmission component 1004 to transmit the systematically polar encoded codeword to a second device, wherein the systematically polar encoded codeword comprises a contiguous set of encoded bits corresponding to the set of information bits and one or more additional encoded bits. In some aspects, the communication manager 1006 may perform one or more operations described elsewhere herein as being performed by one or more components of the communication manager 1006.

In some aspects, the communication manager 1006 includes a set of components, such as an encoding component 1010, a mapping component 1012, a copying component 1014, a puncturing component 1016, and/or a shortening component 1018. Alternatively, the set of components may be separate and distinct from the communication manager 1006. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The encoding component 1010 may perform a first polar encoding operation on a set of information bits to obtain a first set of intermediate bits. The mapping component 1012 may map the first set of intermediate bits contiguously to a second polar encoding operation. The encoding component 1010 may perform the second polar encoding operation on the first set of intermediate bits and a second set of intermediate bits to obtain a systematically polar encoded codeword. The transmission component 1004 may transmit the systematically polar encoded codeword to a second device, wherein the systematically polar encoded codeword comprises a contiguous set of encoded bits corresponding to the set of information bits and one or more additional encoded bits.

The copying component 1014 may copy a subset of the first set of intermediate bits to generate the second set of intermediate bits, wherein the second set of intermediate bits comprises the copied subset of the first set of intermediate bits and a plurality of frozen bits.

The puncturing component 1016 may puncture one or more bits generated by performing the second polar encoding operation to obtain the systematically polar encoded codeword.

The mapping component 1012 may map a subset of the second set of intermediate bits to one or more bit channels of the second polar encoding operation that correspond to the one or more bits that are punctured, wherein each bit in the subset of the second set of intermediate bits is a frozen bit.

The shortening component 1018 may shorten one or more bits generated by performing the second polar encoding operation to obtain the systematically polar encoded codeword.

FIG. 11 is a diagram of an example apparatus 1100 for wireless communication that supports systematic polar encoding operations in accordance with the present disclosure. The apparatus 1100 may be a receiving device, or a receiving device may include the apparatus 1100. In some aspects, the apparatus 1100 includes a reception component 1102, a transmission component 1104, and a communication manager 1106, which may be in communication with one another (for example, via one or more buses). As shown, the apparatus 1100 may communicate with another apparatus 1108 (such as a UE 120, a network node 110, or another wireless communication device) using the reception component 1102 and the transmission component 1104. The communication manager 1106 may be included in, or implemented via, a processing system (for example, the processing system 145). In some aspects, the communication manager 1106 is the communication manager 155.

In some aspects, the apparatus 1100 may be configured to and/or operable to perform one or more operations described herein in connection with FIGS. 3-8. Additionally or alternatively, the apparatus 1100 may be configured to and/or operable to perform one or more processes described herein, such as process 900 of FIG. 9.

The reception component 1102 may receive communications, such as reference signals, control information, and/or data communications, from the apparatus 1108. The reception component 1102 may provide received communications to one or more other components of the apparatus 1100, such as the communication manager 1106. In some aspects, the reception component 1102 may perform signal processing on the received communications, and may provide the processed signals to the one or more other components in a similar manner as described above in connection with FIG. 1. In some aspects, the reception component 1102 may include one or more components of the first device described above in connection with FIG. 1, such as a radio, one or more RF chains, one or more transceivers, or one or more modems, each of which may in turn be coupled with one or more antennas of the first device.

The transmission component 1104 may transmit communications, such as reference signals, control information, and/or data communications, to the apparatus 1108. In some aspects, the communication manager 1106 may generate communications and may transmit the generated communications to the transmission component 1104 for transmission to the apparatus 1108. In some aspects, the transmission component 1104 may perform signal processing on the generated communications, and may transmit the processed signals to the apparatus 1108 in a similar manner as described above in connection with FIG. 1. In some aspects, the transmission component 1104 may include one or more components of the first device described above in connection with FIG. 1, such as a radio, one or more RF chains, one or more transceivers, or one or more modems, each of which may in turn be coupled with one or more antennas of the first device. In some aspects, the transmission component 1104 may be co-located with the reception component 1102.

The communication manager 1106 may receive or may cause the reception component 1102 to receive, from a second device, a systematically polar encoded codeword comprising a contiguous set of encoded bits corresponding to a set of information and one or more additionally encoded bits. The communication manager 1106 may perform a first polar decoding operation on the systematically polar encoded codeword to obtain a first set of intermediate bits and a second set of intermediate bits. The communication manager 1106 may map the second set of intermediate bits contiguously to a second polar decoding operation. The communication manager 1106 may perform the second polar decoding operation on the second set of intermediate bits to obtain the set of information bits. In some aspects, the communication manager 1106 may perform one or more operations described elsewhere herein as being performed by one or more components of the communication manager 1106.

In some aspects, the communication manager 1106 includes a set of components, such as a decoding component 1110, and/or a mapping component 1112. Alternatively, the set of components may be separate and distinct from the communication manager 1106. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1102 may receive, from a second device, a systematically polar encoded codeword comprising a contiguous set of encoded bits corresponding to a set of information and one or more additionally encoded bits. The decoding component 1110 may perform a first polar decoding operation on the systematically polar encoded codeword to obtain a first set of intermediate bits and a second set of intermediate bits. The mapping component 1112 may map the second set of intermediate bits contiguously to a second polar decoding operation. The decoding component 1110 may perform the second polar decoding operation on the second set of intermediate bits to obtain the set of information bits.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:

Aspect 1: A method for wireless communication by a first device, comprising: performing a first polar encoding operation on a set of information bits to obtain a first set of intermediate bits; mapping the first set of intermediate bits contiguously to a second polar encoding operation; performing the second polar encoding operation on the first set of intermediate bits and a second set of intermediate bits to obtain a systematically polar encoded codeword; and transmitting the systematically polar encoded codeword to a second device, wherein the systematically polar encoded codeword comprises a contiguous set of encoded bits corresponding to the set of information bits and one or more additional encoded bits.

Aspect 2: The method of Aspect 1, further comprising: copying a subset of the first set of intermediate bits to generate the second set of intermediate bits, wherein the second set of intermediate bits comprises the copied subset of the first set of intermediate bits and a plurality of frozen bits.

Aspect 3: The method of Aspect 2, wherein the subset of the first set of intermediate bits comprises bits in the first set of intermediate bits that correspond to frozen bit locations associated with the second polar encoding operation.

Aspect 4: The method of any of Aspects 1-3, wherein: mapping the first set of intermediate bits comprises mapping the first set of intermediate bits to a first set of indices of the second polar encoding operation; the method further comprises mapping the second set of intermediate bits to a second set of indices of the second polar encoding operation; and the first set of indices comprise larger indices of the second polar encoding operation than the second set of indices.

Aspect 5: The method of any of Aspects 1-4, wherein a last quantity of bit locations within the systematically polar encoded codeword comprises the contiguous set of encoded bits corresponding to the set of information bits.

Aspect 6: The method of any of Aspects 1-5, wherein: the first polar encoding operation is in accordance with a first polar matrix having a first size; and the second polar encoding operation is in accordance with a second polar matrix having a second size that is different than the first size.

Aspect 7: The method of any of Aspects 1-6, further comprising: puncturing one or more bits generated by performing the second polar encoding operation to obtain the systematically polar encoded codeword.

Aspect 8: The method of Aspect 7, further comprising: mapping a subset of the second set of intermediate bits to one or more bit channels of the second polar encoding operation that correspond to the one or more bits that are punctured, wherein each bit in the subset of the second set of intermediate bits is a frozen bit.

Aspect 9: The method of any of Aspects 1-8, further comprising: shortening one or more bits generated by performing the second polar encoding operation to obtain the systematically polar encoded codeword.

Aspect 10: The method of Aspect 9, wherein: performing the first polar encoding operation comprises performing the first polar encoding operation on the set of information bits and one or more frozen bits; and the one or more frozen bits are mapped to one or more bit channels of the second polar encoding operation that correspond to the one or more bits that are shortened.

Aspect 11: A method for wireless communication by a first device, comprising: receiving, from a second device, a systematically polar encoded codeword comprising a contiguous set of encoded bits corresponding to a set of information and one or more additionally encoded bits; performing a first polar decoding operation on the systematically polar encoded codeword to obtain a first set of intermediate bits and a second set of intermediate bits; mapping the second set of intermediate bits contiguously to a second polar decoding operation; and performing the second polar decoding operation on the second set of intermediate bits to obtain the set of information bits.

Aspect 12: The method of Aspect 11, wherein the second set of intermediate bits comprises a copied subset of the first set of intermediate bits and a plurality of frozen bits.

Aspect 13: The method of Aspect 12, wherein the subset of the first set of intermediate bits comprises bits in the first set of intermediate bits that correspond to information bit locations associated with the first polar decoding operation.

Aspect 14: The method of any of Aspects 11-13, wherein: mapping the second set of intermediate bits comprises mapping the second set of intermediate bits from a first set of indices of the first polar decoding operation to the second polar decoding operation; and the first set of indices comprise larger indices of the first polar decoding operation than a second set of indices associated with the first set of intermediate bits.

Aspect 15: The method of any of Aspects 11-14, wherein a last quantity of bit locations within the systematically polar encoded codeword comprises the contiguous set of encoded bits corresponding to the set of information bits.

Aspect 16: The method of any of Aspects 11-15, wherein: the first polar decoding operation is in accordance with a first polar matrix having a first size; and the second polar decoding operation is in accordance with a second polar matrix having a second size that is different than the first size.

Aspect 17: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.

Aspect 18: An apparatus for wireless communication at a device, the apparatus comprising one or more memories and one or more processors coupled to the one or more memories, the one or more processors configured to cause the device to perform the method of one or more of Aspects 1-16.

Aspect 19: An apparatus for wireless communication, the apparatus comprising at least one means for performing the method of one or more of Aspects 1-16.

Aspect 20: A non-transitory computer-readable medium storing code for wireless communication, the code comprising instructions executable by one or more processors to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

Aspect 22: A device for wireless communication, the device comprising a processing system that includes one or more processors and one or more memories coupled with the one or more processors, the processing system configured to cause the device to perform the method of one or more of Aspects 1-16.

Aspect 23: An apparatus for wireless communication at a device, the apparatus comprising one or more memories and one or more processors coupled to the one or more memories, the one or more processors individually or collectively configured to cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first device for wireless communication, comprising:
a processing system that includes one or more processors and one or more memories coupled with the one or more processors, the processing system configured to cause the first device to:
perform a first polar encoding operation on a set of information bits to obtain a first set of intermediate bits;
map the first set of intermediate bits contiguously to a second polar encoding operation;
perform the second polar encoding operation on the first set of intermediate bits and a second set of intermediate bits to obtain a systematically polar encoded codeword; and
transmit the systematically polar encoded codeword to a second device, wherein the systematically polar encoded codeword comprises a contiguous set of encoded bits corresponding to the set of information bits and one or more additional encoded bits.

2. The first device of claim 1, wherein the processing system is further configured to cause the first device to:
copy a subset of the first set of intermediate bits to generate the second set of intermediate bits, wherein the second set of intermediate bits comprises the copied subset of the first set of intermediate bits and a plurality of frozen bits.

3. The first device of claim 2, wherein the subset of the first set of intermediate bits comprises bits in the first set of intermediate bits that correspond to frozen bit locations associated with the second polar encoding operation.

4. The first device of claim 1, wherein:
to cause the first device to map the first set of intermediate bits, the processing system is configured to cause the first device to map the first set of intermediate bits to a first set of indices of the second polar encoding operation;
the processing system is further configured to cause the first device to map the second set of intermediate bits to a second set of indices of the second polar encoding operation; and
the first set of indices comprise larger indices of the second polar encoding operation than the second set of indices.

5. The first device of claim 1, wherein a last quantity of bit locations within the systematically polar encoded codeword comprises the contiguous set of encoded bits corresponding to the set of information bits.

6. The first device of claim 1, wherein:
the first polar encoding operation is in accordance with a first polar matrix having a first size; and
the second polar encoding operation is in accordance with a second polar matrix having a second size that is different than the first size.

7. The first device of claim 1, wherein the processing system is further configured to cause the first device to:
puncture one or more bits generated by performing the second polar encoding operation to obtain the systematically polar encoded codeword.

8. The first device of claim 7, wherein the processing system is further configured to cause the first device to:
map a subset of the second set of intermediate bits to one or more bit channels of the second polar encoding operation that correspond to the one or more bits that are punctured, wherein each bit in the subset of the second set of intermediate bits is a frozen bit.

9. The first device of claim 1, wherein the processing system is further configured to cause the first device to:
shorten one or more bits generated by performing the second polar encoding operation to obtain the systematically polar encoded codeword.

10. The first device of claim 9, wherein:
to cause the first device to perform the first polar encoding operation, the processing system is configured to cause the first device to perform the first polar encoding operation on the set of information bits and one or more frozen bits; and
the one or more frozen bits are mapped to one or more bit channels of the second polar encoding operation that correspond to the one or more bits that are shortened.

11. A first device for wireless communication, comprising:
a processing system that includes one or more processors and one or more memories coupled with the one or more processors, the processing system configured to cause the first device to:
receive, from a second device, a systematically polar encoded codeword comprising a contiguous set of encoded bits corresponding to a set of information and one or more additionally encoded bits;
perform a first polar decoding operation on the systematically polar encoded codeword to obtain a first set of intermediate bits and a second set of intermediate bits;
map the second set of intermediate bits contiguously to a second polar decoding operation; and
perform the second polar decoding operation on the second set of intermediate bits to obtain the set of information bits.

12. The first device of claim 11, wherein the second set of intermediate bits comprises a copied subset of the first set of intermediate bits and a plurality of frozen bits.

13. The first device of claim 12, wherein the subset of the first set of intermediate bits comprises bits in the first set of intermediate bits that correspond to information bit locations associated with the first polar decoding operation.

14. The first device of claim 11, wherein:
to cause the first device to map the second set of intermediate bits, the processing system is configured to cause the first device to map the second set of intermediate bits from a first set of indices of the first polar decoding operation to the second polar decoding operation; and
the first set of indices comprise larger indices of the first polar decoding operation than a second set of indices associated with the first set of intermediate bits.

15. The first device of claim 11, wherein a last quantity of bit locations within the systematically polar encoded codeword comprises the contiguous set of encoded bits corresponding to the set of information bits.

16. The first device of claim 11, wherein:
the first polar decoding operation is in accordance with a first polar matrix having a first size; and
the second polar decoding operation is in accordance with a second polar matrix having a second size that is different than the first size.

17. A method for wireless communication by a first device, comprising:
performing a first polar encoding operation on a set of information bits to obtain a first set of intermediate bits;
mapping the first set of intermediate bits contiguously to a second polar encoding operation;
performing the second polar encoding operation on the first set of intermediate bits and a second set of intermediate bits to obtain a systematically polar encoded codeword; and
transmitting the systematically polar encoded codeword to a second device, wherein the systematically polar encoded codeword comprises a contiguous set of encoded bits corresponding to the set of information bits and one or more additional encoded bits.

18. The method of claim 17, further comprising:
copying a subset of the first set of intermediate bits to generate the second set of intermediate bits, wherein the second set of intermediate bits comprises the copied subset of the first set of intermediate bits and a plurality of frozen bits.

19. The method of claim 18, wherein the subset of the first set of intermediate bits comprises bits in the first set of intermediate bits that correspond to frozen bit locations associated with the second polar encoding operation.

20. The method of claim 17, wherein:
mapping the first set of intermediate bits comprises mapping the first set of intermediate bits to a first set of indices of the second polar encoding operation;
the method further comprises mapping the second set of intermediate bits to a second set of indices of the second polar encoding operation; and
the first set of indices comprise larger indices of the second polar encoding operation than the second set of indices.

21. The method of claim 17, wherein a last quantity of bit locations within the systematically polar encoded codeword comprises the contiguous set of encoded bits corresponding to the set of information bits.

22. The method of claim 17, wherein:
the first polar encoding operation is in accordance with a first polar matrix having a first size; and
the second polar encoding operation is in accordance with a second polar matrix having a second size that is different than the first size.

23. The method of claim 17, further comprising:
puncturing one or more bits generated by performing the second polar encoding operation to obtain the systematically polar encoded codeword.

24. The method of claim 23, further comprising:
mapping a subset of the second set of intermediate bits to one or more bit channels of the second polar encoding operation that correspond to the one or more bits that are punctured, wherein each bit in the subset of the second set of intermediate bits is a frozen bit.

25. The method of claim 17, further comprising:
shortening one or more bits generated by performing the second polar encoding operation to obtain the systematically polar encoded codeword.

26. The method of claim 25, wherein:
performing the first polar encoding operation comprises performing the first polar encoding operation on the set of information bits and one or more frozen bits; and
the one or more frozen bits are mapped to one or more bit channels of the second polar encoding operation that correspond to the one or more bits that are shortened.

27. A method for wireless communication by a first device, comprising:
receiving, from a second device, a systematically polar encoded codeword comprising a contiguous set of encoded bits corresponding to a set of information and one or more additionally encoded bits;
performing a first polar decoding operation on the systematically polar encoded codeword to obtain a first set of intermediate bits and a second set of intermediate bits;
mapping the second set of intermediate bits contiguously to a second polar decoding operation; and
performing the second polar decoding operation on the second set of intermediate bits to obtain the set of information bits.

28. The method of claim 27, wherein the second set of intermediate bits comprises a copied subset of the first set of intermediate bits and a plurality of frozen bits.

29. The method of claim 28, wherein the subset of the first set of intermediate bits comprises bits in the first set of intermediate bits that correspond to information bit locations associated with the first polar decoding operation.

30. The method of claim 27, wherein:
mapping the second set of intermediate bits comprises mapping the second set of intermediate bits from a first set of indices of the first polar decoding operation to the second polar decoding operation; and
the first set of indices comprise larger indices of the first polar decoding operation than a second set of indices associated with the second set of intermediate bits.
